(19) United States
(12) Patent Application Publication
(10) Pub. No.: US 2012/0278603 A1
(43) Pub. Date: Nov. 1, 2012

(54) DISPLAY DEVICE, REMOTE CONTROLLER, BOOTING METHOD OF THE DISPLAY DEVICE, AND METHOD FOR TRANSMITTING BOOT CONTROL SIGNAL

(76) Inventor: Byongwook LEE, Pyeongtaek-si (KR)

(21) Appl. No.: 13/434,237

(22) Filed: Mar. 29, 2012

(30) Foreign Application Priority Data
Apr. 28, 2011 (KR) 10-2011-0040206

(51) Int. Cl. G06F 9/00

(52) U.S. Cl. 713/2

(57) ABSTRACT

A display device, a remote controller, a booting method of the display device, and a method for transmitting a boot control signal are disclosed, in which a communication module receives a first booting mode signal and a second booting mode signal, and a controller controls booting in a first booting mode, upon receipt of the first booting mode signal and controls booting in a second booting mode, upon receipt of the second booting mode signal.

This application claims the benefit of Korean Patent Application No. 10-2011-0040206, filed on Apr. 28, 2011, which is hereby incorporated by reference as if fully set forth herein.

### BACKGROUND OF THE INVENTION

1. Field of the Invention

The present invention relates to a display device, a remote controller, a booting method of the display device, and a method for transmitting a boot control signal, and more particularly, to a method for booting a display device.

2. Discussion of the Related Art

A display device such as a broadcasting receiver, a personal computer, a laptop, a mobile phone, etc. can be configured to perform a variety of functions. The functions include, for example, broadcast reception, data and voice communication, photographing or recording a video through a camera, voice recording, playback of music through a speaker system, and display of images or videos. Some terminals may further be equipped with a game play function.

Display devices are getting slimmer to increase portability. To facilitate user manipulation, display devices are under development to have an input unit such as a touchpad, a touch screen, etc. When a touchpad or a touch screen is touched, a display device performs an operation corresponding to the touch. The operation corresponds to a selection made on a displayed screen. The operation may also be paging, scrolling, panning, zooming, etc.

Conventionally, booting a display device involves power-on, standby mode, reception of a power-on signal, and normal mode. Since the display device is booted from the standby mode to the normal mode after receiving the power-on signal, a user needs to wait a booting time from the standby mode to the normal mode after pressing a power-on key on a remote controller in order to view an image on the display device.

### SUMMARY OF THE INVENTION

Accordingly, the present invention is directed to a display device, a remote controller, a booting method of booting the display device, and a method for transmitting a boot control signal that substantially obviate one or more problems due to limitations and disadvantages of the related art.

An object of the present invention is to provide a display device, a remote controller, a booting method of the display device, and a method for transmitting a boot control signal, which enable faster booting of the display device.

To achieve these objects and other advantages and in accordance with the purpose of the invention, as embodied and broadly described herein, a method for transmitting a boot control signal includes sensing a first user action, transmitting a first booting mode signal to a display device in response to the sensed first user action, sensing a second user action, and transmitting a second booting mode signal to the display device in response to the sensed second user action.

The first user action may be at least one of an action of moving a remote controller, an action of grabbing the remote controller, or an action of touching the remote controller. The first user action may be sensed by at least one of a gyro sensor, an acceleration sensor, a pressure sensor, or a touch sensor.

The second user action may be an action of pressing a power-on button.

In another aspect of the present invention, a booting method of a display device includes receiving a first booting mode signal, booting in a first booting mode in response to the first booting mode signal, receiving a second booting mode signal, and booting in a second booting mode in response to the second booting mode signal. The first booting mode may be virtual standby mode, and the second booting mode may be normal mode. The display device may operate in standby mode in a power-off state.

The booting method may further include determining whether the second booting mode signal has been received for a predetermined time after receiving the first booting mode signal and powering off, when the second booting mode signal has not been received.

The booting method may further include, upon receipt of a signal in the power-off state, determining whether the received signal is the first booting mode signal or the second booting mode signal.

In another aspect of the present invention, a remote controller includes a detection unit configured to sense a first user action and a second user action, and a controller configured to control transmission of a first booting mode signal to a display device in response to the sensed first user action and to control transmission of a second booting mode signal to the display device in response to the sensed second user action.

The first user action may be at least one of an action of moving a remote controller, an action of grabbing the remote controller, or an action of touching the remote controller. The first user action may be sensed by at least one of a gyro sensor, an acceleration sensor, a pressure sensor, or a touch sensor.

The second user action may be an action of pressing a power-on button.

In a further aspect of the present invention, a display device includes a communication module configured to receive a first booting mode signal and a second booting mode signal, and a controller configured to control booting in a first booting mode, upon receipt of the first booting mode signal and to control booting in a second booting mode, upon receipt of the second booting mode signal. The first booting mode may be virtual standby mode and the second booting mode may be normal mode. The display device operates in standby mode in a power-off state

The controller may determine whether the second booting mode signal has been received for a predetermined time after the first booting mode signal is received, and may control the display device to operate in the power-off state, when the second booting mode signal has not been received.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates the configuration of an electronic system according to a preferred embodiment of the present invention;

FIG. 2 illustrates a table listing signals transmitted from a remote controller according to an embodiment of the present invention;

FIG. 3 is a block diagram of a display device according to a preferred embodiment of the present invention;

FIG. 4 is a block diagram of a remote controller according to a preferred embodiment of the present invention;

FIG. 5 is exemplary left and right side views of the display device according to the present invention;

FIG. 6 illustrates exemplary recognition of hand-touched surfaces of the display device according to the present invention;

FIG. 7 is a state transition diagram illustrating a method for switching an operation mode of the display device according to a preferred embodiment of the present invention;

FIG. 8 illustrates an operation for booting the display device with passage of time in the case where virtual standby mode is not defined according to an embodiment of the present invention;

FIG. 9 illustrates an operation for booting the display device with passage of time in the case where the virtual standby mode is defined according to an embodiment of the present invention;

FIG. 10 illustrates an operation for booting the display device with passage of time in the case where the virtual standby mode is not defined according to another embodiment of the present invention;

FIG. 11 illustrates an operation for booting the display device with passage of time in the case where the virtual standby mode is defined according to another embodiment of the present invention;

FIG. 12 illustrates states of inner modules of the display device according to a preferred embodiment of the present invention;

FIG. 13 is a flowchart illustrating an operation for performing a booting method in the display device according to a preferred embodiment of the present invention;

FIG. 14 is a flowchart illustrating an operation for performing a boot control signal transmission method according to a preferred embodiment of the present invention; and

FIG. 15 is a diagram illustrating a signal flow for an operation for performing the booting method in the display device according to a preferred embodiment of the present invention.

### DETAILED DESCRIPTION OF THE INVENTION

Reference will now be made in detail to the preferred embodiments of the present invention, examples of which are illustrated in the accompanying drawings. The configuration and operation of the present invention as illustrated in and explained by the drawings are described as at least one embodiment, which should not be construed as limiting the technical spirit and the key configuration and operation of the present invention.

Although the terms used in the present invention are selected from generally known and used terms, taking into account functions of the present invention, they are subject to change depending on the intention of an operator in the art, practices, or the advent of a new technology. Some of the terms mentioned in the description of the present invention have been selected by the applicant at his or her discretion, the detailed meanings of which are described in relevant parts of the description herein. Accordingly, the present invention must be understood, not simply by the actual terms used but by the meanings of each term lying within.

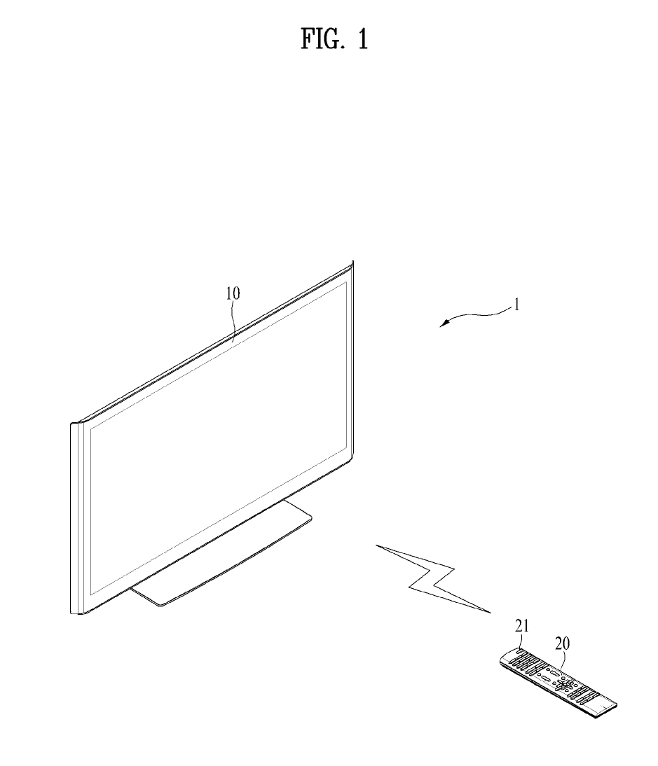

FIG. 1 illustrates the configuration of an electronic system according to a preferred embodiment of the present invention.

Referring to FIG. 1, an electronic system 1 according to the present invention may include a display device 10 and a remote controller 20. The display device 10 may cover a broad range of terminals such as personal computers including a desktop, a laptop, and a hand-held computer, mobile terminals including a portable phone, a smart phone, a digital broadcasting terminal, a Personal Digital Assistant (PDA), a Portable Multimedia Player (PMP), and a navigator, and stationary electronic devices including a digital TV.

The display device 10 and the remote controller 20 may be incorporated into a single product or may be configured into separate products.

The display 10 may receive an operation standby signal and an operation start signal from the remote controller 20. Upon receipt of the operation standby signal, the display device 10 may perform a standby booting operation. Upon receipt of the operation start signal, the display device 10 may perform a normal booting operation or a booting resumption operation. In the description of the present invention, the normal booting operation is the process of performing general booting normally, the standby booting operation is the process of performing only a part of the normal booting operation. Particularly, an operation associated with external output of processed data may not be performed during the standby booting. That is, although modules of the display device 10 process data, the processed data is not output outside during the standby booting operation. To be more specific, the processed data is not output through a module such as a display or a speaker. Therefore, a user may not notice that booting is in progress.

The booting resumption operation is the process of performing the remainder of booting excluded from the standby booting operation.

For the convenience' sake of description, the normal booting operation may include activating an Operating System (OS), loading a necessary application onto a memory, tuning to a channel to be displayed, decoding data received on the tuned channel, and outputting the decoded data through a display. It is to be clearly understood that the normal booting operation is not necessarily the five-step process and thus some of the steps may be omitted or one or more steps may be added. For instance, user authentication or connection to an Access Point (AP) may further be performed in the normal booting operation.

Among the steps of the normal booting operation, the standby booting operation may include only the OS activation and the loading of a necessary application onto a memory. In alternative embodiments, the standby booting operation may include all of the normal booting operation except for the displaying.

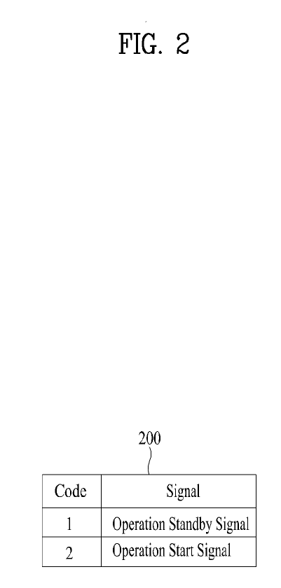

FIG. 2 illustrates a table that lists signals transmitted from a remote controller according to an embodiment of the present invention.

Referring to FIG. 2, a table 200 lists signals transmitted from the remote controller. Code ‘1’ is assigned to an operation standby signal and code ‘2’ is assigned to an operation start signal in the table 200. Upon receipt of a signal indicating code ‘1’ from the remote controller 20, the display device 10 determines that the operation standby signal has been received. Upon receipt of a signal indicating code ‘2’ from the remote controller 20, the display device 10 determines that the operation start signal has been received. In alternative embodiments, other code values may be assigned to the operation standby signal and the operation start signal in the table 200.

The remote controller 20 may transmit the operation standby signal and the operation start signal. Upon receipt of the operation start signal, the display 10 may perform booting to normal mode. On the other hand, upon receipt of the operation standby signal, the display 10 may perform booting to virtual standby mode. The operation start signal is generated when a user presses a ‘power-on’ or ‘start’ button 21 on the remote controller 20. That is, the operation start signal is generated when the user requests starting operation of the display device 10. Likewise, an operation end signal is generated when the user presses the ‘power off’ or ‘end’ button 21 on the remote controller 20. The same code may be assigned to both the operation start signal and the operation end signal.

When the user touches, grabs, or moves the remote controller 20, the operation standby signal is generated. That is, upon sensing at least one of a user action of moving the remote controller 20, a user action of grabbing the remote controller 20, or a user reaction of touching the remote controller 20, the remote controller 20 may generate and transmit the operation standby signal. User actions may include selecting a physical button on the display device 10 or the remote controller 20, drawing a predetermined gesture on the display plane of a touch screen, selecting a soft button on the touch screen, making a predetermined gesture that will be sensed from an image captured by a camera device, and making a predetermined utterance sensed by voice recognition.

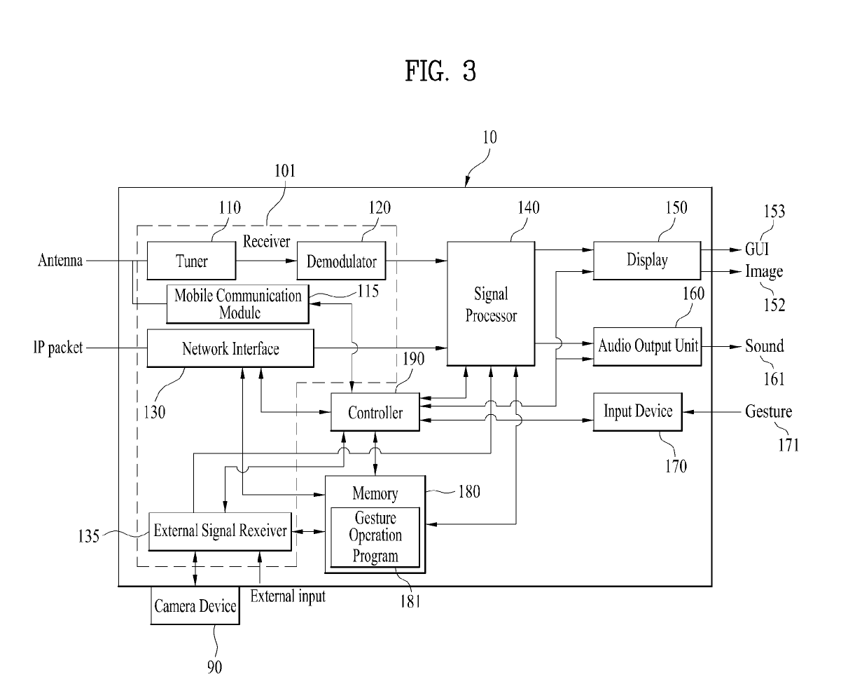

FIG. 3 is a block diagram of the display device according to a preferred embodiment of the present invention.

Referring to FIG. 3, the display device 10 according to the present invention may include a receiver 101, a signal processor 140, a display 150, an audio output unit 160, an input device 170, a memory 180, and a controller 190. The display device 10 may include a camera device 90 in an embodiment of the present invention.

The receiver 101 may receive broadcast data, video data, audio data, information data, and program code. The receiver 101 may include a tuner 110, a demodulator 120, a mobile communication module 115, a network interface 130, and an external signal receiver 135.

The signal processor 140 demultiplexes a stream signal received from the demodulator 120 into a video signal and an audio signal, processes the video signal and the audio signal (i.e. video decoding and audio decoding), and then outputs an image 152 to the display 150 and sound 161 to the audio output unit 160. The signal processor 140 may also receive video data, audio data, and broadcast data from the mobile communication module 115, the network interface 130, and the external signal receiver 135.

The display 150 displays the image 152. The display 150 may operate in connection with the controller 190. The display 150 may display a Graphical User Interface (GUI) 153 that interfaces between a user and an OS or an application executed on the OS.

The audio output unit 160 may receive audio data from the signal processor 140 and the controller 190 and output the sound 161 reproduced from the received audio data.

The input device 170 may be a touch screen disposed on or in front of the display 150 and may be a communication module for receiving signals from the remote controller 20. In an embodiment of the present invention, the receiver 101 may be a communication module for receiving signals from the remote controller 20. Particularly, the external signal receiver 135 may function to receive signals from the remote controller 20.

The memory 180 typically provides space for storing program code and data used by the display device 10. The memory 180 may be configured to include a Read Only Memory (ROM), a Random Access Memory (RAM), a hard disk drive, etc. The program code and data may exist in a detachable storage medium so that they may be loaded onto the display device 10, when needed. Detachable storage media may include a CD-ROM, a PC-CARD, a memory card, a floppy disk, a magnetic tape, and a network component.

The controller 190 executes commands and performs operations associated with the display device 10. For example, the controller 190 may control input and output and data reception and processing between components of the display device 10, using commands retrieved from the memory 180. The controller 190 may be implemented on a single chip, a plurality of chips, or a plurality of electrical parts. For example, diverse architectures such as a dedicated or embedded processor, a single-purpose processor, an Application Specific Integrated Circuit (ASIC), etc. are available for implementation of the controller 190.

The controller 190 executes computer code and generates and uses data in conjunction with the OS. The OS is well-known and will not be described in detail herein. The OS may be any of an OS from Windows series, Unix, Linux, Palm OS, DOS, Android, Macintosh, etc. The OS, other computer code, and data may exist in the memory 180 that operates in connection with the controller 190.

The controller 190 may sense a user action and control the display device 10 based on the sensed user action.

Gestures may include a touch gesture and a spatial gesture. A touch gesture may be defined as a formalized interaction with the input device 170, mapped to one or more specific computing operations. A touch gesture may be made with a hand or hands, particularly with finger motions in many ways. Alternatively or additionally, a gesture may be drawn with a stylus.

The input device 170 receives a gesture 171 and the controller 190 executes a command for performing an operation associated with the gesture 171. The memory 180 may include a gesture operation program 181 that may be a part of the OS or a part of an independent application. The gesture operation program 181 generally includes a series of commands that recognize occurrence of the gesture 171 and notify one or more software agents of the gesture 171 and/or an action or actions to be taken in response to the gesture 171.

The controller 190 may decide on an operation mode for the display device 10 and control the display device 10 to operate in the decided operation mode. The operation mode may be one of standby mode, virtual standby mode, and normal mode.

The standby mode refers to a state where external power is not supplied to the display device 10 or any or most of the inner modules of the display device 10 do not operate despite supply of external power. For example, the input device 170 alone may operate to receive signals from the remote controller 20 in the standby mode.

The virtual standby mode refers to a state where some hardware drivers or modules of the display device 10 do not operate or stay in a minimum power consumption state. For example, a program may stay in the memory 180 and power may be supplied only to the input device 170 for receiving signals from the remote controller 20 in the virtual standby mode. In another example, power may be supplied to all other modules except modules for outputting data externally in the virtual standby mode. In addition, although data is not output externally in the virtual standby mode, the virtual standby mode may fast switch to the normal mode through booting resumption, when the operation start signal is received from the user.

The normal mode refers to a state where most (or all) of the inner modules of the display 10 operate. The display device 10 may normally output data outside in the normal mode.

When the controller 190 has not received the operation start signal from the remote controller 20 until standby booting is completed after receiving the operation standby signal in the standby mode, the controller 190 may control the display device 10 to operate in the virtual standby mode. For example, the controller 190 may control power supply in such a manner that power is supplied only to the memory 180 having an application or a booting image and a module that will perform a booting resumption operation, while power is cut to the other output-related modules (e.g. the display 150 and the audio output 160).

Upon receipt of the operation start signal in the standby mode, the controller 190 may control the display device 10 to operate in the normal mode.

Upon receipt of the operation start signal in the virtual standby mode, the controller 190 may control the display device 10 to operate in the normal mode. Herein, the controller 190 may control performing of the booting resumption operation. For example, a booting image may be stored in the memory 180 and the controller 190 may perform the booting resumption operation using the stored booting image in the virtual standby mode. In another example, the controller 190 may perform the booting resumption operation using a booting image pre-stored in the memory 180 in the virtual standby mode.

Conventionally, the virtual standby mode was not defined as an operation mode for a display device. Therefore, a user cannot view a broadcast program until normal booting is completed. Because the normal booting operation takes a long time, the user waits long to view the broadcast program after pressing the ‘start’ button 21 on the remote controller 20. In contrast, the present invention sets the virtual standby mode as one of the operation modes of the display device 10 and, upon receipt of an operation start signal in the virtual standby mode, provides broadcasting through booting resumption. Since the booting resumption operation takes a shorter time than the normal booting operation, the user can view the broadcast program faster than in the conventional display device.

When the virtual standby mode lasts a threshold time or longer, the controller 190 may control the display device 10 to operate in the standby mode. Power is consumed in the virtual standby mode due to power supply to some modules of the display device 10. Power consumption can be reduced by switching the display device 10 from the virtual standby mode to the standby mode when the predetermined threshold time has elapsed. The threshold time may be set by a user, in the process of product fabrication, or by the controller 190 in consideration of the use habit of the user.

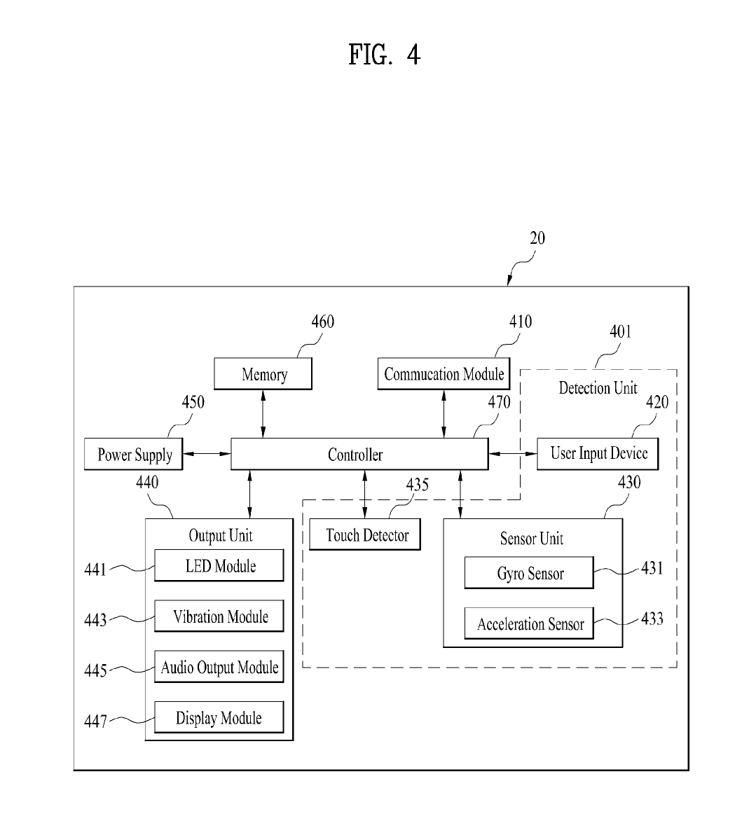

FIG. 4 is a block diagram of the remote controller according to a preferred embodiment of the present invention.

Referring to FIG. 4, the remote controller 20 may include a detection unit 401, a communication module 410, an output unit 440, a power supply 450, a memory 460, and a controller 470.

The detection unit 401 may sense a user action. The detection unit 401 may include a user input unit 420, a sensor unit 430, and a touch detector 435.

The communication module 410 provides means for interactive non-directional (or omni-directional) communication. The communication module 410 may communicate wirelessly with the display device 10 according to a communication scheme conforming to a predetermined communication standard. The communication standard may be any of Zigbee, Bluetooth, Ultra Wideband (UWB), Radio Frequency IDentification (RFID), and Wireless Local Area Network (WLAN).

The communication module 410 may transmit a Radio Frequency (RF) or InfraRed (IR) signal carrying a control signal to the display device 10. The control signal may deliver information about a motion that the remote controller has made or a command such as power on/off, channel switching, volume change, etc. The control signal may also be the operation standby signal or the operation start signal.

The controller 470 may provide overall control to the remote controller 20. The controller 470 may control the communication module 410 to transmit a control signal.

The user input unit 420 may be configured into a keypad, a button, a touchpad, or a touch screen. The user may input a command to control the display device 10 with the remote controller 20 by manipulating the user input unit 420. When the user presses the ‘start’ button in the user input unit 420, the controller 470 may generate the operation start signal and may control the communication module 410 to transmit the operation start signal.

The sensor unit 430 may include a gyro sensor 431 and an acceleration sensor 433.

The gyro sensor 431 may sense a motion that the remote controller 20 has made and thus may generate sensing information corresponding to the motion. For example, the gyro sensor 431 may sense a motion of the remote controller along the x, y and z axes and generate information indicating a spatial vector based on the sensed result.

The acceleration sensor 433 may sense the velocity of the remote controller 20 and thus may generate sensing information indicating the sensed velocity.

When the gyro sensor 431 senses a motion of the remote controller 20, the controller 470 may control generation and transmission of the operation standby signal.

Likewise, when the acceleration sensor 433 senses the velocity of the remote controller 20, the controller 470 may control generation and transmission of the operation standby signal.

The touch detector 435 may sense a user touch as a user action taken regarding the remote controller 20. When the touch detector 435 senses a user touch on the remote controller 20, the controller 470 may control generation and transmission of the operation standby signal.

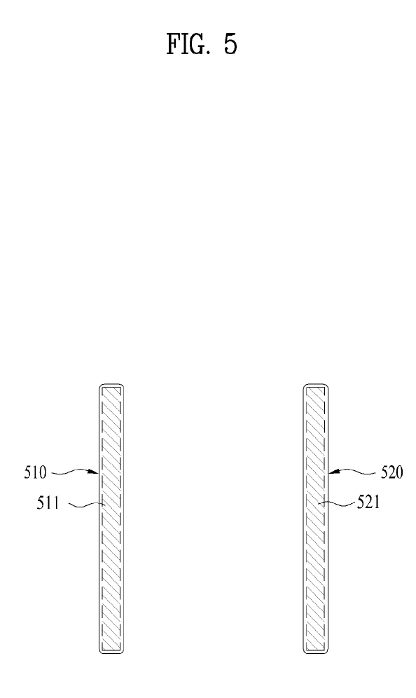

FIG. 5 is exemplary left and right side views of the display device according to the present invention.

Referring to FIG. 5, a left side surface 510 and a right side surface 520 of the remote controller 20 are purely exemplary. The touch detector 435 may include a first touch detector 511 provided on the left side surface 510 and a second touch detector 521 provided on the right side surface 520. In an embodiment of the present invention, the first and second touch detectors 511 and 521 may be configured into single-sensors disposed on both side surfaces of the remote controller 20. In this case, each of the first and second touch detectors 511 and 521 may be configured into a multi-touch sensor that can detect the coordinates or number of one or more touch spots at which the touch detector 435 is touched. When the user grabs the remote controller 20 with the left or right hand, the first and second touch detectors 511 and 521 may detect the coordinates or number of spots touched by the hand.

In an embodiment of the present invention, the first and second touch detectors 511 and 512 may be configured into pressure sensors for sensing applied pressure. When the user grabs the remote controller 20 with the left or right hand, the first and second touch detectors 511 and 521 detect spots that the hand presses.

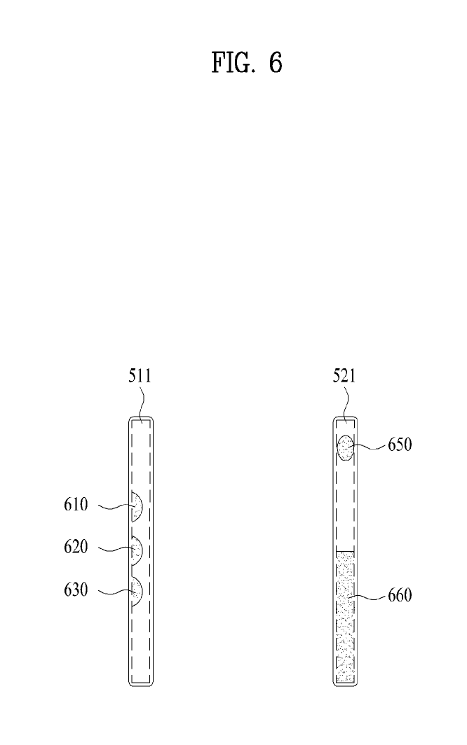

FIG. 6 illustrates exemplary recognition of hand-touched surfaces of the display device according to the present invention.

Referring to FIG. 6, when the user grabs the remote controller 20 with the right hand, the touch detector 435 may detect touch spots as illustrated in FIG. 6. The first touch detector 511 may detect a plurality of touch spots 610, 620 and 630. The touch spots 610, 620 and 630 may correspond to touches made by the index, middle, and ring fingers of the right hand. Depending on how the user grabs the remote controller 20, the first touch detector 511 may detect four touch spots instead of three touch spots.

The second touch detector 521 may detect a plurality of touch spots 650 and 660. The touch spots 650 and 660 may correspond to touches made by the thumb of the right hand and an under-the-thumb part of the right palm.

The output unit 440 may output a video or audio signal corresponding to manipulation of the user input unit 420 or corresponding to a signal received from the display device 10. The output unit 440 may include a Light Emitting Diode (LED) module 441 for illuminating upon manipulation of the user input unit 420 or upon signal transmission or reception to and from the display device 10, a vibration module 443 for generating vibrations, an audio output module 445 for outputting sound, or a display module 447 for outputting an image.

The power supply 450 supplies power to the remote controller 20. When the remote controller 20 is kept stationary for a predetermined time, the power supply 450 cuts power to the remote controller 20 in order to save power. Upon manipulation of a predetermined key in the remote controller 20, the power supply 450 may resume power supply to the remote controller 20.

The memory 460 may store many kinds of programs and program data required to control and operate the display device 10. The memory 460 may further store information about a frequency band.

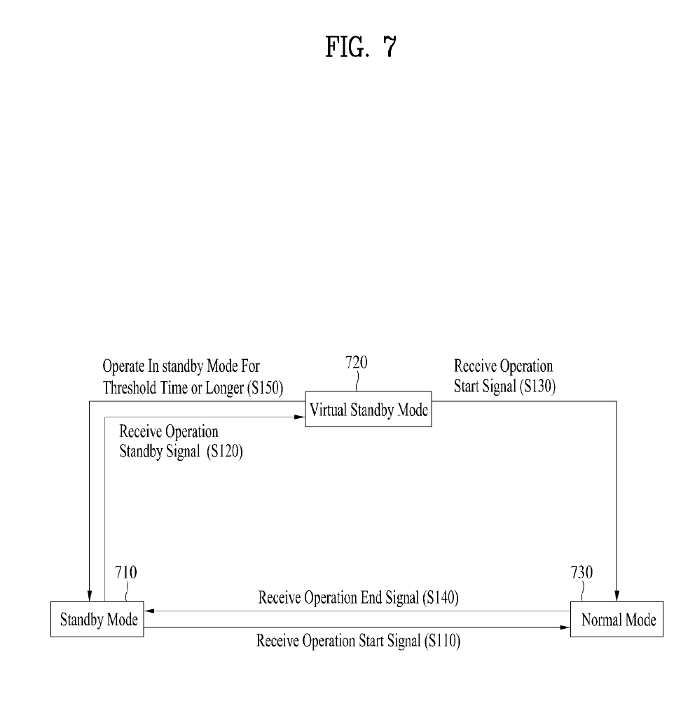

FIG. 7 is a state transition diagram illustrating a method for switching an operation mode of the display device according to a preferred embodiment of the present invention.

Referring to FIG. 7, when the input device 170 receives the operation start signal in standby mode 710, the controller 190 controls the normal booting operation to be performed (S110). Upon completion of the normal booting operation, the display device 10 operates in normal mode 730.

On the other hand, upon receipt of the operation standby signal at the input device 170 in the standby mode 710, the controller 190 controls the standby booting operation to be performed (S120). Upon completion of the standby booting operation, the display device 10 operates in virtual standby mode 720.

Upon receipt of the operation start signal at the input device 170 in the virtual standby mode 720, the controller 190 controls the booting resumption operation to be performed (S130). Upon completion of the booting resumption operation, the display device 10 operates in the normal mode 730.

Upon receipt of the operation end signal at the input device 170 in the normal mode 730, the controller 190 controls the display device 10 to operate in the standby mode 710 (S140).

When the operation start signal has not been received for a threshold time or longer in the virtual standby mode 720, the controller 190 controls the display device 10 to operate in the standby mode 710 (S150).

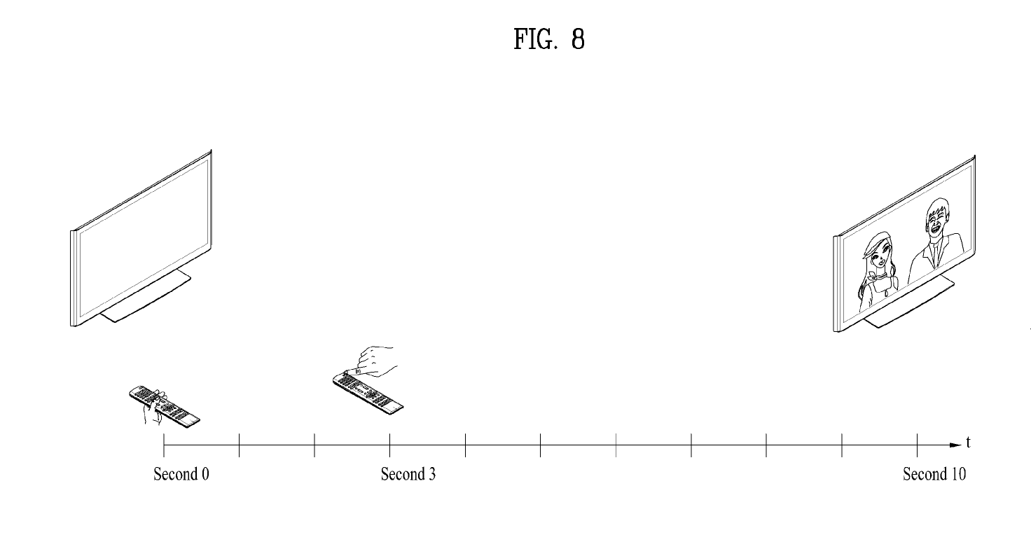

FIG. 8 illustrates an operation for booting the display device with passage of time in the case where the virtual standby mode is not defined.

For the convenience' sake of description, it is assumed that the display device 10 takes 7 seconds to complete the normal booting operation, 5 seconds to complete the standby booting operation, and 2 seconds to complete the booting resumption operation.

FIG. 8 illustrates an operation of the display device 10 with the virtual standby mode not defined as an operation mode, when the display device 10 receives the operation start signal 3 seconds after the user grabs the remote controller 20.

The user grabs the remote controller 20 at second 0 and presses the ‘start’ button at second 3. With the virtual standby mode not defined, booting of the display device 10 starts at the moment when the operation start signal is received. Therefore, the display device 10 is inoperative during second 0 to second 3. After second 3, the display device 10 receives the operation start signal and starts the normal booting operation. Consequently, the display device 10 is completely booted 10 seconds after the user grabs the remote controller 20 and then displays a broadcast program.

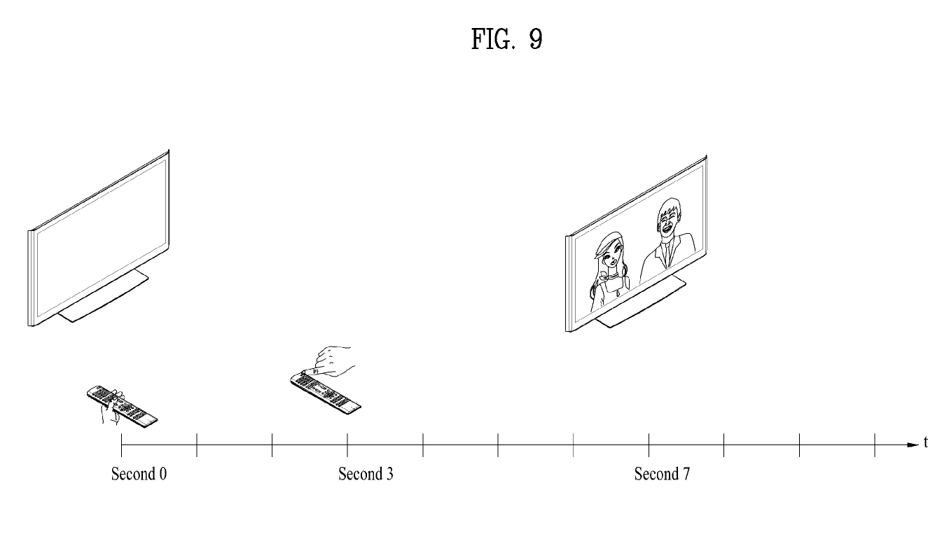

FIG. 9 illustrates an operation for booting the display device with passage of time in the case where the virtual standby mode is defined.

FIG. 9 illustrates an operation of the display device 10 with the virtual standby mode defined as an operation mode, when the display device 10 receives the operation start signal 3 seconds after the user grabs the remote controller 20.

The user grabs the remote controller 20 at second 0. As the virtual standby mode exists, the remote controller 20 senses the user action of grabbing the remote controller 20 at second 0 and transmits the operation standby signal to the display device 10. The display device 10 receives the operation standby signal at second 0 and starts booting at the moment when the operation standby signal is received.

The user presses the ‘start’ button at second 3. The remote controller 20 senses a user action of pressing the ‘start’ button at second 3 and transmits the operation start signal to the display device 10. At second 3 when the display device 10 receives the operation start signal, the standby booting is still in progress. From second 3 on, therefore, the normal booting operation following the so-far performed booting operation. Consequently, the display device 10 is completely booted 7 seconds after the user grabs the remote controller 20 and then displays a broadcast program. The user can view the broadcast program 4 seconds after pressing the ‘start’ button. That is, the booting operation of the display device 10 is completed 4 seconds after the ‘start’ button is pressed, on the part of the user. Compared to the booting operation of FIG. 8, the booting operation of FIG. 9 can reduce a booting delay of about 3 seconds.

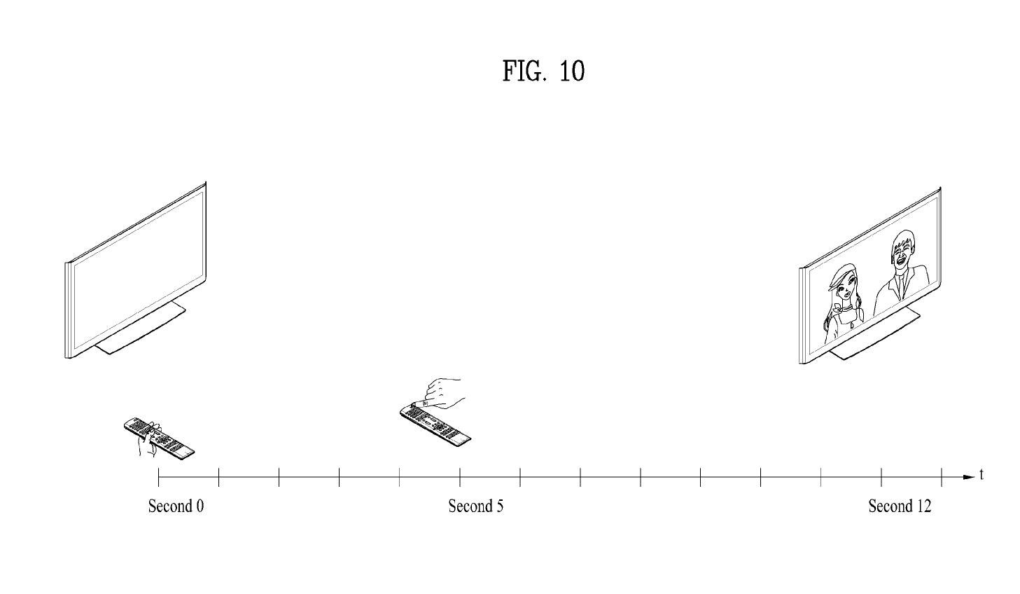

FIG. 10 illustrates an operation for booting the display device with passage of time in the case where the virtual standby mode is not defined according to another embodiment of the present invention.

FIG. 10 illustrates an operation of the display device 10 with the virtual standby mode not defined as an operation mode, when the display device 10 receives the operation start signal 5 seconds after the user grabs the remote controller 20.

The user grabs the remote controller 20 at second 0 and presses the ‘start’ button at second 5. With the virtual standby mode not defined, booting of the display device 10 starts at the moment when the operation start signal is received. Therefore, the display device 10 is inoperative during second 0 to second 5. After second 5, the display device 10 receives the operation start signal and starts the normal booting operation. Consequently, the display device 10 is completely booted 12 seconds after the user grabs the remote controller 20 and then displays a broadcast program.

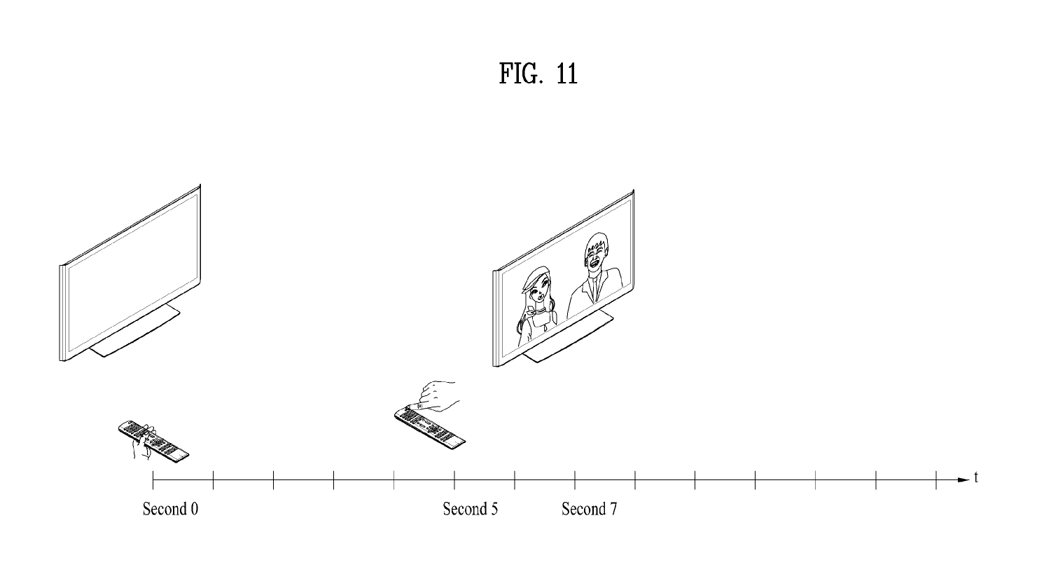

FIG. 11 illustrates an operation for booting the display device with passage of time in the case where the virtual standby mode is defined according to another embodiment of the present invention.

FIG. 11 illustrates an operation of the display device 10 with the virtual standby mode defined as an operation mode, when the display device 10 receives the operation start signal 5 seconds after the user grabs the remote controller 20.

The user grabs the remote controller 20 at second 0. As the virtual standby mode exists, the remote controller 20 senses the user action of grabbing the remote controller 20 at second 0 and transmits the operation standby signal to the display device 10. The display device 10 receives the operation standby signal at second 0 and starts booting at the moment when the operation standby signal is received.

The user presses the ‘start’ button at second 5. The remote controller 20 senses the user action of pressing the ‘start’ button at second 5 and transmits the operation start signal to the display device 10. The standby booting has been completed by second 5 when the display device 10 receives the operation start signal. Since the operation start signal has not been received until the standby booting is completed, the display device 10 operates in the virtual standby mode.

As the display device 10 receives the operation start signal in the virtual standby mode, the display device 10 performs the booting resumption operation. Consequently, the display device 10 is completely booted 7 seconds after the user grabs the remote controller 20 and then displays a broadcast program. Thus, the user can view the broadcast program 2 seconds after pressing the ‘start’ button. That is, the booting operation of the display device 10 is completed 2 seconds after the ‘start’ button is pressed, on the part of the user. Compared to the booting operation of FIG. 10, the booting operation of FIG. 11 can reduce a booting delay of about 5 seconds.

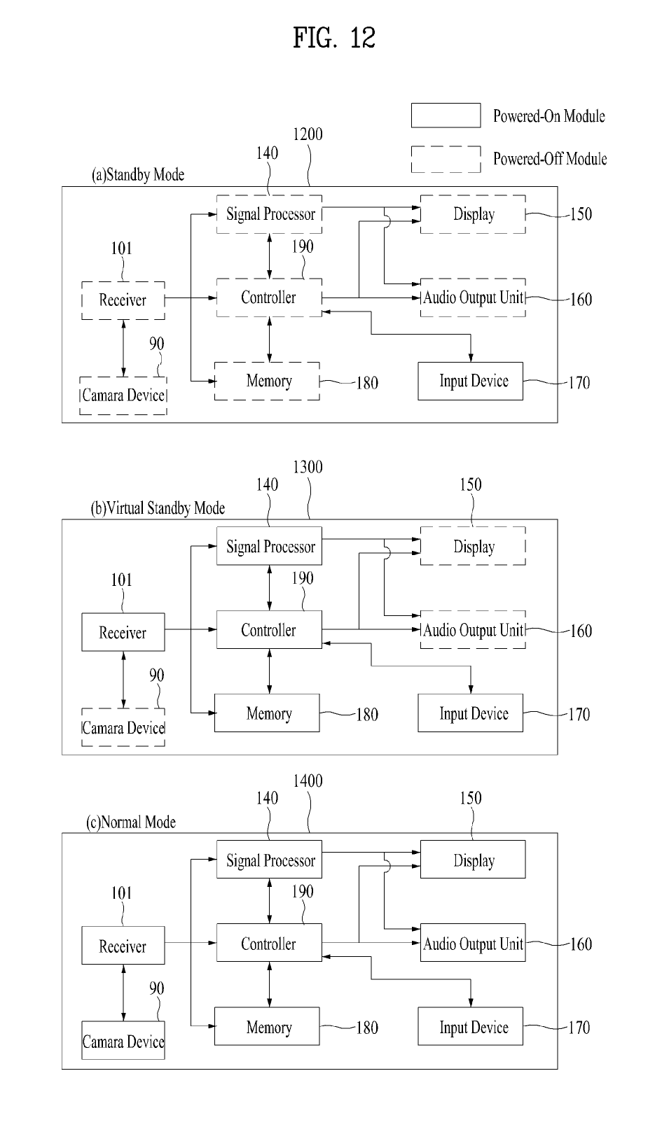

FIG. 12 illustrates states of inner modules of the display device according to a preferred embodiment of the present invention.

Referring to FIG. 12, power may be supplied only to the input device 170, with power cut to the camera device 90, the receiver 101, the signal processor 140, the display 150, the audio output unit 160, the memory 180, and the controller 190, in standby mode 1200 of FIG. 12(a). Among other functions of the input device 170, particularly the function of receiving signals from the remote controller 20 may be activated for the input device 170. In an embodiment of the present invention, when the receiver 101 receives a signal from the remote controller 20, power may be supplied to the receiver 101 instead of the input device 170 in the standby mode 1200.

In virtual standby mode 1300 of FIG. 12(b), power may be supplied to the receiver 101, the signal processor 140, the input device 170, the memory 180, and the controller 190, with power cut to the camera device 90, the display 150, and the audio output unit 160.

In normal mode 1400 of FIG. 12(c), power may be supplied to the camera device 90, the receiver 101, the signal processor 140, the display 150, the audio output unit 160, the input device 170, the memory 180, and the controller 190.

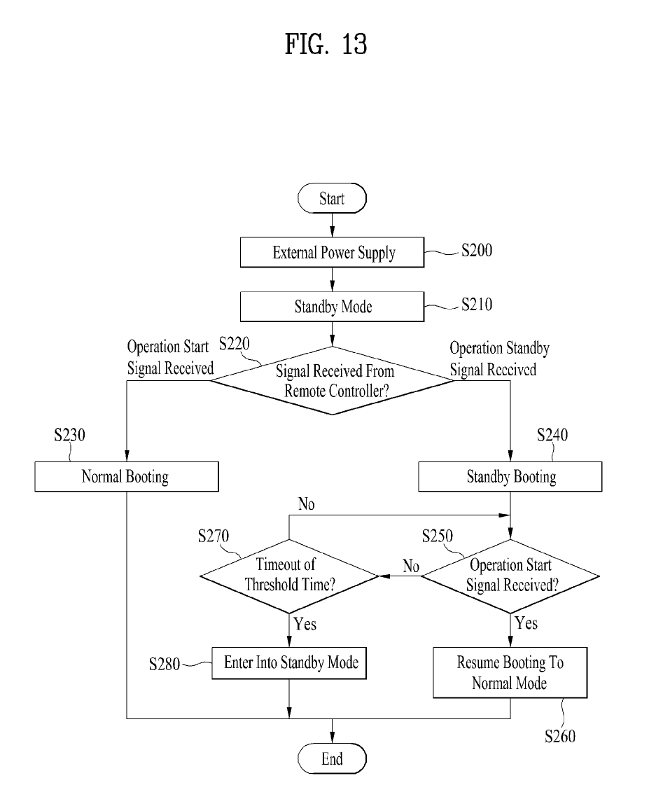

FIG. 13 is a flowchart illustrating an operation for performing a booting method in the display device according to a preferred embodiment of the present invention.

Referring to FIG. 13, external power is supplied to the display device 10 (S200).

The display device 10 operates in the standby mode (S210).

The display device 10 monitors reception of a signal from the remote controller 20 (S220). Herein, the display device 10 may determine whether the operation start signal or the operation standby signal has been received from the remote controller 20.

Upon receipt of the operation start signal, the display device 10 performs the normal booting operation (S230). When the normal booting operation is completed, the display device 10 operates in the normal mode.

On the other hand, upon receipt of the operation standby signal, the display device 10 performs the standby booting operation (S240). When the standby booting operation is completed, the display device 10 operates in the virtual standby mode.

The display 10 monitors reception of the operation start signal (S250). The display device 10 may perform step S150 during the standby booting operation or in the virtual standby mode after the standby booting operation. That is, the operation start signal may be received during the standby booting operation or during operation in the virtual standby mode.

Upon receipt of the operation start signal, the display device 10 performs the operation of resuming booting to the normal mode (S 260). Upon completion of the booting resumption operation, the display device 10 operates in the normal mode.

When the operation start signal has not been received, the display device 10 determines whether a threshold time or longer has elapsed (S270). The threshold time may be counted starting from the moment when the operation standby signal is received or the standby booting operation is completed.

Upon timeout of the threshold time, the display device 10 enters into the standby mode (S280). Then, the display device 10 operates in the standby mode.

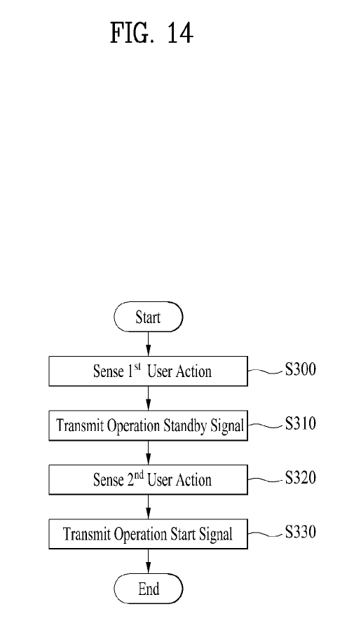

FIG. 14 is a flowchart illustrating an operation for performing a boot control signal transmission method according to a preferred embodiment of the present invention.

Referring to FIG. 14, the remote controller 20 senses a first user action (S300). The first user action may be at least one of an action of moving the remote controller 20, an action of grabbing the remote controller 20, or an action of touching the remote controller 20. The first user action may be sensed by at least one of a gyro sensor, an acceleration sensor, a pressure sensor, or a touch sensor. Herein, the sensor unit 430 or the touch detector 435 may sense the first user action.

The remote controller 20 transmits the operation standby signal in response to the first user action (S310). Upon receipt of the operation standby signal, the display device 10 may perform standby booting.

The remote controller 20 senses a second user action (S320). The second user action may be an action of pressing the ‘power-on’ or ‘start’ button. The user input device 420 may sense the second user action.

The remote controller 20 transmits the operation start signal in response to the sensed second user action (S330). Upon receipt of the operation start signal, the display device 10 may resume booting.

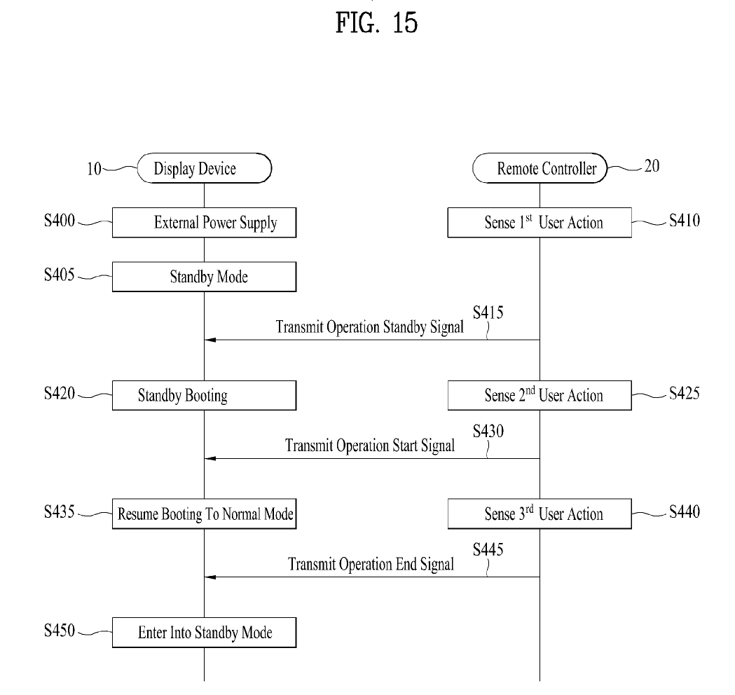

FIG. 15 is a diagram illustrating a signal flow for an operation for performing the booting method in the display device according to a preferred embodiment of the present invention.

Referring to FIG. 15, external power is supplied to the display device 10 (S400).

The display device 10 operates in the standby mode (S405).

The remote controller 20 senses a first user action (S410). The first user action may be at least one of an action of moving the remote controller 20, an action of grabbing the remote controller 20, or an action of touching the remote controller 20. The first user action may be sensed by at least one of a gyro sensor, an acceleration sensor, a pressure sensor, or a touch sensor. Herein, the sensor unit 430 or the touch detector 435 may sense the first user action.

The remote controller 20 transmits the operation standby signal in response to the sensed first user action (S415).

The display device 10 performs the standby booting operation (S420). Upon completion of the standby booting operation, the display device 10 operates in the virtual standby mode.

The remote controller 20 senses a second user action (S425). The second user action may be an action of pressing the ‘power-on’ or ‘start’ button. The user input device 420 may sense the second user action.

The remote controller 20 transmits the operation start signal in response to the sensed second user action (S430).

The display device 10 may resume booting to the normal mode (S435). Upon completion of the booting resumption operation, the display device 10 operates in the normal mode.

The remote controller 20 senses a third user action (S440).

The remote controller 20 transmits the operation end signal in response to the sensed third user action (S445).

The display device 10 enters into the standby mode (S450). Then the display device 10 operates in the standby mode.

As is apparent from the above description of the display device, the remote controller, the booting method of the display device, and the method for transmitting a boot control signal according to the present invention, since a user action is sensed and a part of booting is performed in advance, a booting delay time felt by a user can be reduced.

The present invention may be implemented as code that can be written on a computer-readable recording medium and can thus be read by a processor. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission through the Internet). The computer-readable recording medium can be distributed over a plurality of computer systems connected to a network so that computer-readable code is written thereto and executed therefrom in a decentralized manner.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A booting method of a display device, comprising:
receiving a first booting mode signal;
booting in a first booting mode in response to the first booting mode signal;
receiving a second booting mode signal; and
booting in a second booting mode in response to the second booting mode signal.

2. The booting method according to claim 1, wherein the first booting mode is virtual standby mode.

3. The booting method according to claim 1, wherein the second booting mode is normal mode.

4. The booting method according to claim 1, further comprising:
determining whether the second booting mode signal has been received for a predetermined time after receiving the first booting mode signal; and
powering off, when the second booting mode signal has not been received.

5. The booting method according to claim 1, further comprising, upon receipt of a signal in a power-off state, determining whether the received signal is the first booting mode signal or the second booting mode signal.

6. The booting method according to claim 5, wherein the display device operates in standby mode in the power-off state.

7. A display device comprising:
a communication module configured to receive a first booting mode signal and a second booting mode signal; and
a controller configured to control booting in a first booting mode, upon receipt of the first booting mode signal and to control booting in a second booting mode, upon receipt of the second booting mode signal.

8. The display device according to claim 7, wherein the first booting mode is virtual standby mode.

9. The display device according to claim 7, wherein the second booting mode is normal mode.

10. The display device according to claim 7, wherein the controller determines whether the second booting mode signal has been received for a predetermined time after the first booting mode signal is received, and controls the display device to operate in a power-off state, when the second booting mode signal has not been received.

11. The display device according to claim 7, wherein upon receipt of a signal in a power-off state, the controller determines whether the received signal is the first booting mode signal or the second booting mode signal.

12. The display device according to claim 11, wherein the display device operates in standby mode in the power-off state.

13. A method for transmitting a boot control signal, comprising:
sensing a first user action;
transmitting a first booting mode signal to a display device in response to the sensed first user action;
sensing a second user action; and
transmitting a second booting mode signal to the display device in response to the sensed second user action.

14. The method according to claim 13, wherein the first user action is at least one of an action of moving a remote controller, an action of grabbing the remote controller, or an action of touching the remote controller.

15. The method according to claim 13, wherein the first user action is sensed by at least one of a gyro sensor, an acceleration sensor, a pressure sensor, or a touch sensor.

16. The method according to claim 13, wherein the second user action is an action of pressing a power-on button.

17. A remote controller comprising:
a detection unit configured to sense a first user action and a second user action; and
a controller configured to control transmission of a first booting mode signal to a display device in response to the sensed first user action and to control transmission of a second booting mode signal to the display device in response to the sensed second user action.

18. The remote controller according to claim 17, wherein the first user action is at least one of an action of moving a remote controller, an action of grabbing the remote controller, or an action of touching the remote controller.

19. The remote controller according to claim 17, wherein the first user action is sensed by at least one of a gyro sensor, an acceleration sensor, a pressure sensor, or a touch sensor.

20. The remote controller according to claim 17, wherein the second user action is an action of pressing a power-on button.
